(19) United States
(12) Patent Application Publication
(10) Pub. No.: US 2010/0248582 A1
(43) Pub. Date: Sep. 30, 2010

(54) Decorative & protective Christmas tree base & assemblage

(76) Inventor: Dorothy Tome, Hypoluxo, FL (US)

Correspondence Address: Robert J. Van Der Wall;Suite 701, Grand Bay Plaza, 2665 South Bayshore Drive, Coconut Grove, FL, 33133, US

(21) Appl. No.: 12/383,481

(22) Filed: Mar. 26, 2009

(51) Int. Cl. A63J 19/00; F16M 13/00

(52) U.S. Cl. 446/82; 248/346.01

(57) ABSTRACT

A decorative & protective Christmas tree base & assemblage includes a large combination of features consisting of a preferably electrified base member with a plurality of perforations holding an array of sockets for light bulbs for optional lighting of various miniature buildings being surrounded by a white picket fence protecting the display from being dislodged by gifts under or near the tree, use of a white cotton padding cover simulating snow covering the Christmas tree stand, optionally a model train set with a train station, a plurality of miniature buildings such as a post office, bank, church, fire station, police station, and train station of sufficient number and variety to constitute a village, an ice skating rink with moving magnetic figures constituting skaters, all or any number of which can be placed in a infinite variety of locations by the owner, a multiplicity of figurines constituting villagers and optionally the characters of a nativity scene with a manger, angels, choristers, wise men, shepherds, sheep, camels, cattle, dogs and cats, all or any number of which can also be placed in a infinite variety of locations by the owner.

### BACKGROUND OF THE INVENTION

1. Field of the Invention

The present invention relates to the field of functional and decorative Christmas tree accessories. More specifically, it concerns a prefarably electrified base member having a plurality of perforations holding an array of sockets for light bulbs for optional lighting of various miniature buildings being surrounded by a white picket fence protecting the display from being dislodged by gifts under or near the tree. It also relates to a multiplicity of elements that are placed around and over a Christmas tree stand that supports the tree in a vertical posture. The multiplicity of elements include first a sheet-like cover material that is preferably white to simulate snow. The cover material has at least two functions, i.e., to cover and camouflage the Christmas tree stand, and to provide an attractive surface on which is placed a selection of the remaining of the multiplicity of elements. The cover material preferably includes a plurality of slits through which can be inserted light bulbs placed in selected sockets in the preferably electrified base member to light the interiors of various miniature buildings placed on top of the cover material.

2. Description of the Prior Art

Christmas trees have been a part of the Christmas holiday celebration for more than one hundred years. Originally, all Christmas trees were live trees that were cut down in the forest and brought indoors for the holiday period. This necessitated a means to hold the live tree in a vertical configuration and suggested a means to protect the interior flooring or carpet from tree sap, pine needles and other live tree droppings. In recent decades, artificial trees have become available and popular, but these also frequently use a separate structure to hold the tree in a vertical configuration. These structures are generally termed Christmas tree stands. Often they can be used with both live and artificial trees, and so they frequently contain a reservoir for water to immerse the stump of a live tree to help keep the tree fresh.

Christmas tree stands are generally unattractive structures, especially since many of them are designed to accommodate varying tree diameters such as occurs with live trees. The varying diameters require adjusting screws or the like that often project outward from the structure. Some of the prior art has the objective of hiding or disguising the Christmas tree stand. Examples of this are Taylor, U.S. Pat. No. 4,061,306 for a Decoration Platform Assembly; and Sofy et al., U.S. Pat. No. 6,041,545 for a Decorative Surround for Display Stand. Sometimes such prior art structures are accompanied by other decorative features such electrified or static display model trains and structures. Examples are Sofy et al., U.S. Pat. No. 6,041,545 for a Decorative Surround for Display Stand; Chapin, U.S. Pat. No. 5,131,618 for an Elevated Christmas Tree Track; and Cummings, U.S. Pat. No. 5,211,366 for an Ornamental Support for Christmas Tree and the Like.

No prior art known to Applicant includes the particular combination of features of the present invention. It includes an electrified base member with a plurality of perforations having an array of sockets for light bulbs for optional lighting of various miniature buildings being surrounded by a white picket fence protecting the display from being dislodged by gifts under or near the tree, use of a white cotton padding cover simulating snow covering the Christmas tree stand. The foregoing include the functional objective of protecting the flooring or carpeting from tree sap and other tree dropping.

Other features of the invention include optionally a model train set that is preferably placed around the outside of the village white picket fence, a nativity scene, a plurality of miniature buildings such as houses, a post office, bank, church, fire station, and police station of sufficient number and variety to constitute a village, and an optional ice skating rink with moving magnetic figures constituting skaters, all or any number of which can be placed in a infinite variety of locations by the owner. Further features of the invention include a multiplicity of figurines constituting villagers and optionally the characters of the nativity scene with a manger holding a baby, angels, choristers, wise men, shepherds, sheep, camels, cattle, dogs and cats, all or any number of which can also be placed in a infinite variety of locations by the owner.

In contrast to the prior art, the owner of the invention can design a different display every year using all or as much of the large variety of buildings, figurines, and animals as he or she desires.

### SUMMARY OF THE INVENTION

Bearing in mind the foregoing, it is a principal object of the invention to provide both a decorative and a protective Christmas tree base along with an assemblage of miniature buildings, figurines and animals comprising a village.

It is a related principal object of the invention to accomplish the foregoing objective with an apparatus that hides the Christmas tree stand.

It is another principal object of the invention to empower the owner of the invention to design and construct a different display every Christmas because of the infinite variety of components to be used in a given year and an infinite variety of locations for the placement of the inventive components.

It is an additional related object of the invention to allow the owner of the apparatus of the invention the freedom to deselect any number of components of the apparatus of the invention because of the large selection of same.

It is a further object of the invention to surround the invention with a white picket fence to protect the positioning of the components of the apparatus of the invention from intrusion by gifts under the Christmas tree.

It is another object of the invention to employ a base containing a plurality of perforation holding an array of sockets for light bulbs for optional lighting of various miniature buildings in an infinite variety of locations.

Other objects and advantages of the present invention will be apparent to those skilled in the art upon review of the following descriptions and appended drawings.

In accordance with a primary aspect of the invention, there is provided a large combination of features including an electrified base member with a plurality of perforations having an array of sockets for light bulbs for optional lighting of various miniature buildings being surrounded by a white picket fence protecting the display from being dislodged by gifts under or near the tree, use of a white cotton padding cover simulating snow covering the Christmas tree stand, optionally a model train set with a train station, a plurality of miniature buildings such as a post office, bank, church, fire station, police station, and train station of sufficient number and variety to constitute a village, an ice skating rink with moving magnetic figures constituting skaters, all or any number of which can be placed in a infinite variety of locations by the owner, a multiplicity of figurines constituting villagers and optionally the characters of a nativity scene with a manger, angels, choristers, wise men, shepherds, sheep, camels, cattle, dogs and cats, all or any number of which can also be placed in a infinite variety of locations by the owner.

### BRIEF DESCRIPTION OF THE DRAWINGS

Various other features of the invention will become apparent to those skilled in the art from the following discussion taken in conjunction with the appended drawings, in which:

FIG. 1 is a perspective view of the electrified base member having the plurality of sockets, surrounding white picket fence, Christmas tree stand into which has been placed the Christmas tree trunk.

FIG. 2 is a perspective closeup view showing the cover material camouflaging the Christmas tree stand and one of the infinite number of options in the placement of miniature buildings and figurines, featuring the nativity scene and related figures in the front center right above the stairs.

FIG. 3 is a perspective view showing the fully decorated Christmas tree above the completed inventive decorative and protective Christmas tree base and assemblage.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structures.

Reference is now made to the drawings, wherein like characteristics and features of the present invention shown in the various figures are designated by the same reference numerals.

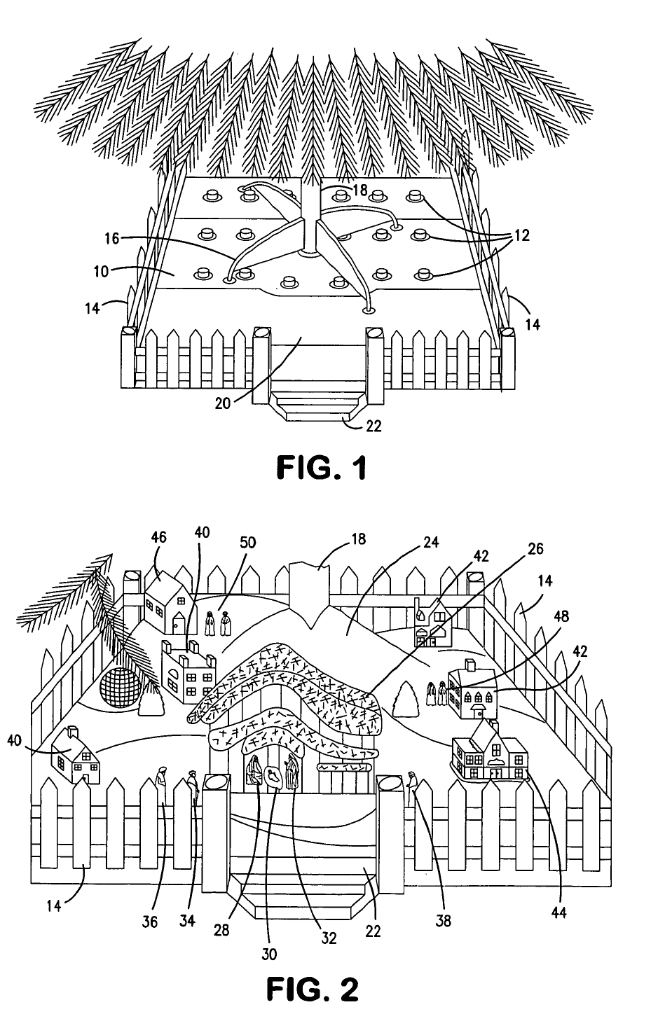

FIG. 1 is a perspective view of the electrified base member 10 having the plurality of sockets 12, surrounding white picket fence 14, Christmas tree stand 16 into which has been placed the Christmas tree trunk 18. In the front is the white picket fence opening 20 and stairs 22.

FIG. 2 is a perspective closeup view showing the cover material 24 camouflaging the Christmas tree stand 16 and one of the infinite number of options in the placement of miniature buildings and figurines features the nativity scene 26 in the front center directly above the stairs 22. The nativity scene includes Mary 28, baby Jesus 30, Joseph 32, and wise men 34, 36, and 38. Also seen are village houses 40 and 42, and a plurality of other miniature buildings 44 and 46 that may be any of the following: post office, bank, church, fire station, and police station. Also visible are choristers 48 and villagers 50. The skating rink, model train set and train station are not shown, but would preferably be placed outside of the white picket fence 14.

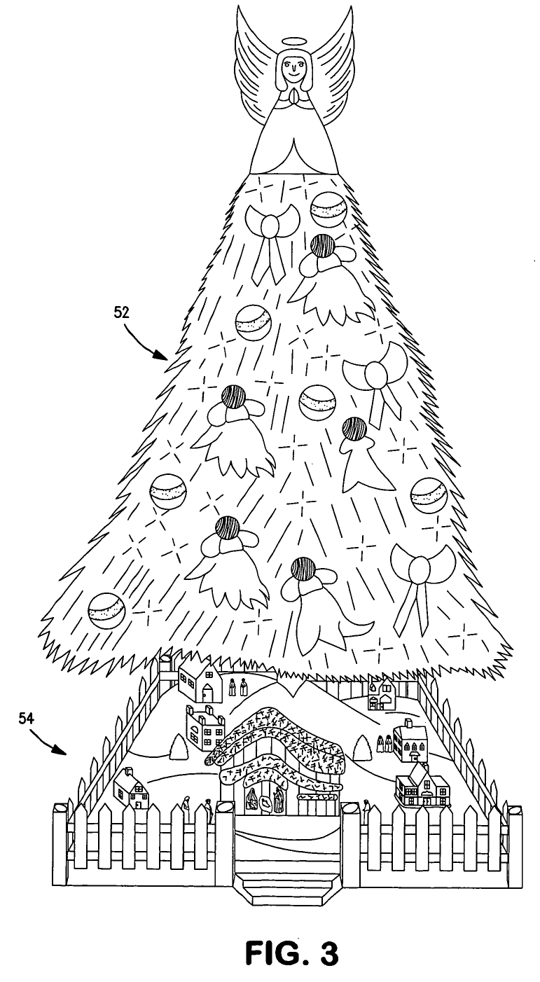

FIG. 3 is a perspective view showing the fully decorated Christmas tree 52 above the completed inventive decorative and protective Christmas tree base and assemblage 54.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A decorative & protective Christmas tree base & assemblage comprising:
a base member;
a white picket fence surrounding the base member;
a white cover material camouflaging a Christmas tree stand and serving as a supporting surface upon which is placed a variety of miniature buildings selected by a user from such as a nativity scene, houses, a post office, bank, church, fire station, and police station of sufficient number and variety to constitute a village, said supporting surface also holding figurines such as villagers, nativity characters such as baby Jesus, Mary, Joseph, wisemen, shepherds, angels, choristers, sheep, camels, dogs, cats; and
the supporting surface being of sufficient size to allow an infinite variety of selection and placement of the miniature buildings and figurines.

2. The Christmas tree base & assemblage of claim 1 further comprising:
the base member having an array of sockets into which may selectively be inserted light bulbs;
the white cover material having an array of slits through which may be selectively inserted the light bulbs;
the light bulbs being inserted into bottoms of the miniature buildings to illuminate them;
the arrays of sockets and slits being of sufficient number to allow an infinite variety of selection and placement of the miniature buildings and figurines.

3. The Christmas tree base & assemblage of claim 1 in which the base member includes a sufficient area so that it provides a means to protect interior flooring and carpet from tree sap, pine needles and other live tree droppings.

4. The Christmas tree base & assemblage of claim 1 further comprising a front opening in the white picket fence.

5. The Christmas tree base & assemblage of claim 1 further comprising a model train set with train station surrounding the white picket fence.

6. The Christmas tree base & assemblage of claim 1 further comprising a simulated ice skating rink with moving magnetic skaters.
